(19) United States
(12) Patent Application Publication
(10) Pub. No.: US 2023/0089064 A1
(43) Pub. Date: Mar. 23, 2023

(54) SURFACE INSPECTION APPARATUS, NON-TRANSITORY COMPUTER READABLE MEDIUM STORING PROGRAM, AND SURFACE INSPECTION METHOD

(71) Applicant: FUJIFILM Business Innovation Corp., Tokyo (JP)

(72) Inventors: Kiyofumi AIKAWA, Kanagawa (JP); Takashi HIRAMATSU, Kanagawa (JP); Kaito TASAKI, Kanagawa (JP); Miho UNO, Kanagawa (JP); Hirokazu ICHIKAWA, Kanagawa (JP); Hiroko ONUKI, Kanagawa (JP); Yoshitaka KUWADA, Kanagawa (JP)

(73) Assignee: FUJIFILM Business Innovation Corp., Tokyo (JP)

(21) Appl. No.: 17/665,576

(22) Filed: Feb. 6, 2022

(30) Foreign Application Priority Data
Sep. 22, 2021 (JP) 2021-153909

(51) Int. Cl. G01N 21/88

(52) U.S. Cl. CPC G01N 21/8806; G01N 2021/8883; G01N 2021/8887

(57) ABSTRACT

A surface inspection apparatus includes an imaging device that images a surface of an object to be inspected, and a processor configured to: calculate an evaluation value of a texture of the object through processing of an image imaged by the imaging device; and detect reflection of a cause of erroneous calculation of the image within a specific range based on at least brightness information of the image.

### CROSS-REFERENCE TO RELATED APPLICATIONS

This application is based on and claims priority under 35 USC 119 from Japanese Patent Application No. 2021-153909 filed Sep. 22, 2021.

### BACKGROUND

### (i) Technical Field

The present invention relates to a surface inspection apparatus, a non-transitory computer readable medium storing a program, and a surface inspection method.

### (ii) Related Art

Today, in various products, parts made by molding synthetic resin (hereinafter referred to as “molded products”) are used. Since a texture is one of items that determine the impression of an appearance, a process of inspecting ae texture of a molded product is provided in a development phase. Since the molded product often has a complicated three-dimensional shape and the inspection of the texture is required even after assembly, an inspection apparatus having a narrow imaging range may be used.

### SUMMARY

Incidentally, a partial region of the imaging range is used for the evaluation of the texture. In the inspection apparatus having the narrow imaging range, the region used for evaluating the texture is also narrowed. Therefore, it becomes difficult to correctly position a defect to be inspected in the region used for the evaluation of the texture. In a case where the defect is not in the correct position, the calculated value does not be a correct evaluation value of a defective portion. The imaging range may include an extremely dark portion or an extremely bright portion. In this case, the calculated value is not used for the evaluation of the defective portion.

In either case, an expert can notice an abnormality in an evaluation value from an imaged image used for the evaluation, but an operator who is not accustomed to the inspection cannot notice the abnormality in the calculated evaluation value.

Aspects of non-limiting embodiments of the present disclosure relate to a surface inspection apparatus, a non-transitory computer readable medium storing a program, and a surface inspection method that reliability of inspection is improved as compared with a case where an evaluation value is calculated without detecting the presence of reflection as a cause of erroneous calculation.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a surface inspection apparatus including an imaging device that images a surface of an object to be inspected, and a processor configured to: calculate an evaluation value of a texture of the object through processing of an image imaged by the imaging device; and detect reflection of a cause of erroneous calculation of the image within a specific range based on at least brightness information of the image.

### BRIEF DESCRIPTION OF THE DRAWINGS

Exemplary embodiment(s) of the present invention will be described in detail based on the following figures, wherein:

FIG. 1 is a diagram illustrating a usage example of a surface inspection apparatus assumed in a first exemplary embodiment;

FIGS. 2A and 2B are diagrams illustrating an example of defects appearing on a surface of an inspection target, FIG. 2A shows an example of a sink mark, and FIG. 2B shows an example of a weld;

FIG. 3 is a diagram illustrating an example of a hardware configuration of the surface inspection apparatus used in the first exemplary embodiment;

FIG. 4 is a diagram illustrating a structural example of an optical system of the surface inspection apparatus according to the first exemplary embodiment;

FIG. 5 is a diagram illustrating an example of an operation screen displayed on a display;

FIG. 6 is a flowchart illustrating an example of an inspection operation by the surface inspection apparatus used in the first exemplary embodiment;

FIGS. 7A to 7C are diagrams illustrating a relationship between an imaged image and a brightness profile, FIG. 7A shows an image example in which a highly reliable score can be calculated and a corresponding brightness profile example, and FIGS. 7B and 7C show an image example in which a score having a reliability problem is calculated and a corresponding brightness profile example;

FIGS. 8A and 8B are diagrams illustrating a display example of an operation screen at the time of execution of a defect inspection, FIG. 8A shows a display example in a case where a region as a cause of erroneous calculation is not reflected in an inspection range, and FIG. 8B shows a display example in a case where the region as the cause of the erroneous calculation is reflected in the inspection range;

FIG. 9 is a flowchart illustrating an example of an inspection operation by a surface inspection apparatus used in a second exemplary embodiment;

FIG. 10 is a flowchart illustrating an example of an inspection operation by a surface inspection apparatus used in a third exemplary embodiment;

FIG. 11 is a diagram illustrating an example of a method for notifying the reflection of the region as the cause of the erroneous calculation;

FIGS. 12A and 12B are diagrams illustrating another example of the method for notifying the reflection of the region as the cause of the erroneous calculation, FIGS. 12A and 12B show an example in which a location having a possibility of a problem is surrounded by a frame;

FIG. 13 is a flowchart illustrating an example of an inspection operation by a surface inspection apparatus used in a fourth exemplary embodiment;

FIGS. 14A and 14B are diagrams illustrating a display example of an operation screen in a case where the region as the cause of the erroneous calculation is reflected, FIG. 14A shows a notification example of reflection, and FIG. 14B shows a notification example of reliability;

FIG. 15 is a flowchart illustrating an example of an inspection operation by a surface inspection apparatus used in a fifth exemplary embodiment;

FIG. 16 is a flowchart illustrating an example of an inspection operation by a surface inspection apparatus used in a sixth exemplary embodiment;

FIGS. 17A and 17B are diagrams illustrating a display example of an operation screen in a case where there is a possibility that the region as the cause of the erroneous calculation is reflected, FIG. 17A shows a notification example of reflection, and FIG. 17B shows a display example in a case where a score is calculated based on an instruction of an operator;

FIG. 18 is a flowchart illustrating an example of an inspection operation by a surface inspection apparatus used in a seventh exemplary embodiment;

FIG. 19 is a flowchart illustrating an example of an inspection operation by a surface inspection apparatus used in an eighth exemplary embodiment;

FIG. 20 is a diagram illustrating a usage example of a surface inspection apparatus used in a ninth exemplary embodiment; and

FIG. 21 is a diagram illustrating a usage example of a surface inspection apparatus used in a tenth exemplary embodiment.

### DETAILED DESCRIPTION

Hereinafter, exemplary embodiments of the present invention will be described with reference to the drawings.

### First Exemplary Embodiment

### Usage Example of Surface Inspection Apparatus

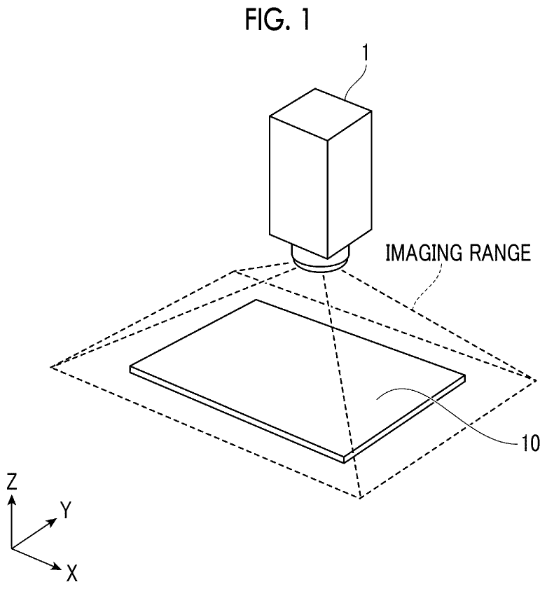

FIG. 1 is a diagram illustrating a usage example of a surface inspection apparatus 1 assumed in a first exemplary embodiment.

The surface inspection apparatus 1 used in the first exemplary embodiment is a so-called area camera, and a range to be imaged (hereinafter referred to as an “imaging range”) is defined by a surface.

In the case of FIG. 1, the imaging range includes the entire object to be inspected (hereinafter also referred to as an “inspection target”) 10. However, the imaging range may include only a portion of the inspection target 10 of interest. A molded product is assumed as the inspection target 10 in the present exemplary embodiment.

In the case of the inspection by the area camera, the inspection by the surface inspection apparatus 1 and the inspection target 10 is performed in a stationary state. In other words, the inspection of the surface of the inspection target 10 is performed in a state where the surface inspection apparatus 1 and the inspection target 10 do not move relatively.

In the case of FIG. 1, the inspection target 10 has a plate shape, but the surface of the inspection target 10 may have any shape. For example, the inspection target 10 may have a shape having a curved surface such as a sphere or a cylinder, in addition to a polyhedron.

The actual inspection target 10 may have holes, notches, protrusions, steps, and the like.

The types of surface finishes of the inspection target 10 include untreated, mirror-finished, quasi-mirror-finished, and textured. The texturing is a process of intentionally forming minute irregularities on the surface of the inspection target 10. Textures of the textured surface change depending on an area ratio of a convex portion and a concave portion, a size of the convex portion, a pattern formed by the irregularities, a height difference between the irregularities, a surface material, a color, and the like.

The surface inspection apparatus 1 inspects defects and textures of the surface of the inspection target 10.

The defects include, for example, sink marks and welds. The sink mark refers to a dent on the surface generated in a thick portion or a rib portion, and the weld refers to a streak generated in a portion where tips of a molten resin join in a mold. The defects also include scratches and dents caused by hitting an object.

The texture is a visual or tactile impression, and is influenced by the color, luster, and irregularities of the surface of the object. The irregularities of the surface also include fine streaks generated in cutting the mold. This type of streak is different from the defect.

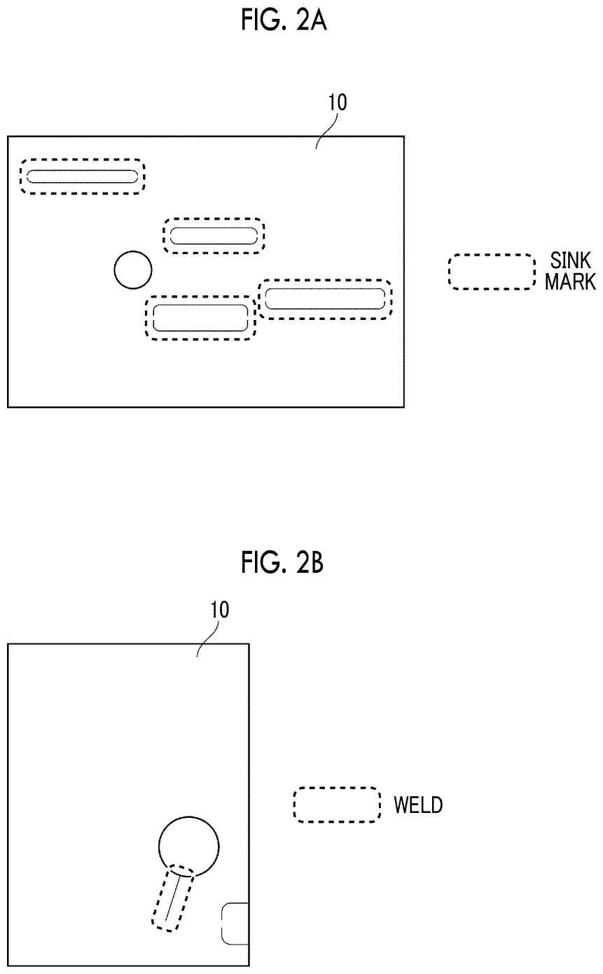

FIGS. 2A and 2B are diagrams illustrating an example of defects appearing on the surface of the inspection target 10. FIG. 2A shows an example of a sink mark, and FIG. 2B shows an example of a weld. In FIGS. 2A and 2B, the defective portion is surrounded by a broken line. There are four sink marks in FIG. 2A. The sink marks and welds are irregularities and streaks appearing in the portion that need to be originally flat.

The description is referred back to FIG. 1. The surface inspection apparatus 1 according to the present exemplary embodiment is used not only for inspection of defects and texture, but also for inspection of surface stains.

The surface inspection apparatus 1 has a function of quantifying a result of evaluating the texture of the surface of the inspection target 10 and displaying the result.

The texture is expressed by a numerical value (hereinafter also referred to as a “score”). The score is an example of a numerical value representing the quality of the surface of the inspection target 10.

For example, multivariate analysis is used to calculate the score. In the multivariate analysis, for example, features appearing in a brightness distribution are analyzed. An example of the feature includes a streaky pattern extending along a direction of the sink mark, for example.

In addition, there is also a method of using artificial intelligence to calculate the score. For example, a score of a partial region positioned within the inspection range is calculated by giving an image imaged by a camera to a learning model obtained by deep machine learning of a relationship between an image obtained by imaging the defect and a score.

The inspection target 10 shown in FIG. 1 is installed parallel to planes defined by an X axis and a Y axis. In this case, the normal of the surface of the inspection target 10 is parallel to a Z axis.

The surface inspection apparatus 1 is arranged vertically above the inspection target 10. In the case of FIG. 1, an optical axis of the camera that images the surface of the inspection target 10 is substantially parallel to the normal of the surface of the inspection target 10. However, a position of the optical axis of the camera with respect to the surface of the inspection target 10 also differs depending on a light source within the surface inspection apparatus 1 and an attachment position of the camera.

Hereinafter, conditions required for imaging the surface of the inspection target 10 are also referred to as “imaging conditions”.

The surface inspection apparatus 1 is installed at a position that satisfies the imaging conditions. The surface inspection apparatus 1 may be fixed to a specific member or may be removable from a specific member.

However, the surface inspection apparatus 1 may be a portable apparatus. In a case where the surface inspection apparatus is the portable apparatus, a person in charge of inspection (hereinafter referred to as an “operator”) images the surface of the inspection target 10 by holding the surface inspection apparatus 1 in his or her hand and directing the camera toward the inspection target 10. Although the surface inspection apparatus 1 shown in FIG. 1 is separated from the surface of the inspection target 10, the inspection may be performed in a state where the surface inspection apparatus 1 is in contact with the surface of the inspection target 10.

In FIG. 1, for the purpose of describing a positional relationship between the surface inspection apparatus 1 and the inspection target 10, an appearance of the surface inspection apparatus 1 is simplified and represented as a substantially rectangular parallelepiped. However, the appearance of the surface inspection apparatus 1 is not limited to the substantially rectangular parallelepiped.

Configuration of Surface Inspection Apparatus

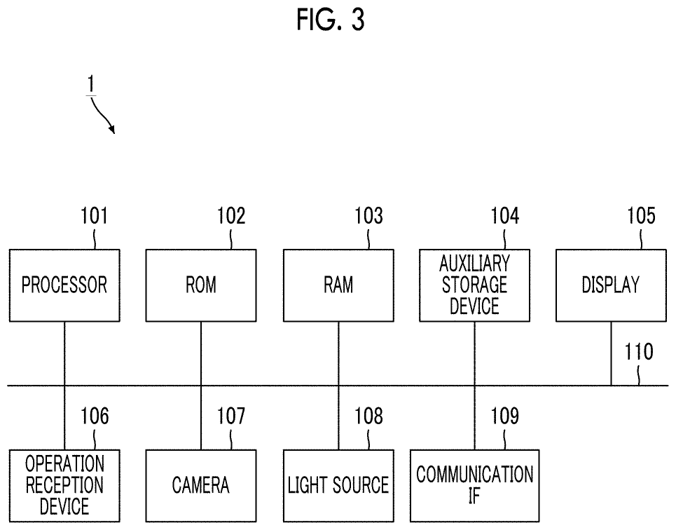

FIG. 3 is a diagram illustrating an example of a hardware configuration of the surface inspection apparatus 1 used in the first exemplary embodiment.

The surface inspection apparatus 1 shown in FIG. 3 includes a processor 101 that controls an operation of the entire apparatus, a read only memory (ROM) 102 in which a basic input output system (BIOS) and the like are stored, a random access memory (RAM) 103 used as a work area of the processor 101, an auxiliary storage device 104 in which programs and image data are stored, a display 105 that displays an imaged image of the surface of the inspection target 10 or information on operations, an operation reception device 106 that receives operations of the operator, a camera 107 that images the surface of the inspection target 10, a light source 108 that illuminates the surface of the inspection target 10, and a communication interface (IF) 109 used for communication with the outside. The processor 101 and each part are connected to each other through a signal line 110 such as a bus.

The processor 101, the ROM 102, and the RAM 103 function as so-called computers. The processor 101 realizes various functions through the execution of the program. For example, the processor 101 performs the calculation or the like of the score for evaluating the texture of the imaged surface of the inspection target 10 through the execution of the program.

Image data obtained by imaging the surface of the inspection target 10 is stored in the auxiliary storage device 104. For the auxiliary storage device 104, for example, a semiconductor memory or a hard disk device is used. Firmware and application programs are also stored in the auxiliary storage device 104. Hereinafter, firmware and application programs are collectively referred to as a “program”.

The display 105 is, for example, a liquid crystal display or an organic EL display, and is used for displaying an image obtained by imaging the inspection target 10 and displaying information representing the texture. The display 105 is also used for positioning the imaging range with respect to the inspection target 10.

In the case of the present exemplary embodiment, the display 105 is integrally provided in the main body of the surface inspection apparatus, but may be a monitor connected through the communication IF 109 or may be a display of a terminal device connected through the communication IF 109. For example, the display 105 may be a display of another computer connected through the communication IF 109. For example, the other computer may be a notebook computer or a smartphone.

The operation reception device 106 is configured with a touch sensor arranged on the display 105, physical switches and buttons arranged on a housing, and the like.

In the case of the present exemplary embodiment, a power button and an imaging button are provided as an example of the physical buttons. In a case where the power button is operated, for example, the light source 108 is turned on and the imaging by the camera 107 is started. Further, in a case where the imaging button is operated, a specific image imaged by the camera 107 at the time of operation is acquired as an image for inspection.

A device that integrates the display 105 and the operation reception device 106 is called a touch panel. The touch panel is used to receive operations of the operator on keys displayed in software (hereinafter also referred to as “soft keys”).

In the case of the present exemplary embodiment, a color camera is used as the camera 107. For an image sensor of the camera 107, for example, a charge coupled device (CCD) imaging sensor or a complementary metal oxide semiconductor (CMOS) imaging sensor is used.

Since a color camera is used as the camera 107, it is possible in principle to observe not only the brightness of the surface of the inspection target 10 but also color information. The camera 107 is an example of an imaging device.

In the case of the present exemplary embodiment, a white light source is used as the light source 108. The white light source generates light in which light in a visible light band is evenly mixed.

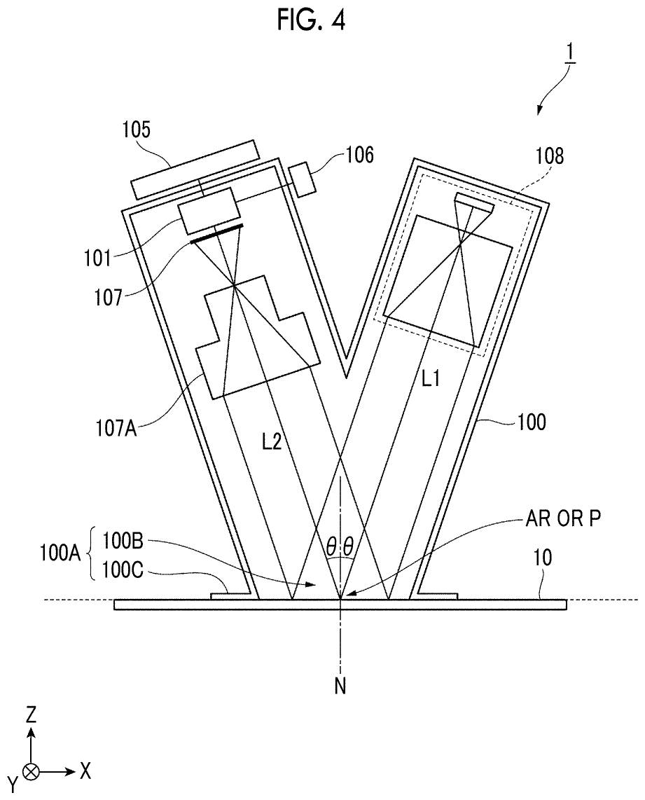

In the case of the present exemplary embodiment, a parallel light source is used as the light source 108. A telecentric lens is used for an imaging lens 107A (see FIG. 4) arranged on the optical axis of the camera 107.

The light source 108 in the present exemplary embodiment is arranged at an angle at which a light component mirror-reflected on the surface of the inspection target 10 is mostly incident on the camera 107.

The communication IF 109 is configured with a module conforming to a wired or wireless communication standard. For the communication IF 109, for example, an Ethernet (registered trademark) module, a universal serial bus (USB), a wireless LAN, or the like is used.

Structure of Optical System

FIG. 4 is a diagram illustrating a structural example of an optical system of the surface inspection apparatus 1 according to the first exemplary embodiment. An opening portion 100A is provided in a part of a housing 100 of the surface inspection apparatus 1.

An opening 100B into which illumination light illuminating the surface of the inspection target 10 and reflected light reflected by the surface of the inspection target 10 are input or output, and a flange 100C surrounding the periphery of the opening 100B are provided in the opening portion 100A. In other words, the opening 100B is provided as a hole provided near a center of the flat plate-shaped flange 100C.

In the case of FIG. 4, both the opening 100B and the flange 100C have a circular shape. The opening 100B and the flange 100C may have other shapes. For example, the opening and the flange may have a rectangular shape.

The opening 100B and the flange 100C may not have similar shapes, the opening 100B may have a circular shape, and the flange 100C may have a rectangular shape.

The flange 100C is used for positioning the surface inspection apparatus 1 in an imaging direction with respect to the surface of the inspection target 10. In other words, the flange 100C is used for positioning the camera 107 and the light source 108 with respect to the surface to be inspected. The flange 100C also serves to prevent or reduce the incident of external light or ambient light on the opening 100B.

The housing 100 shown in FIG. 4 has a structure in which two members having a substantially cylindrical shape are connected. The processor 101, the camera 107, and the imaging lens 107A are housed in one of the cylindrical members. The light source 108 is housed in the other cylindrical member.

Further, the display 105 and the operation reception device 106 are attached to an outer surface of the cylindrical member on the side where the camera 107 is attached.

The imaging lens 107A is arranged on an optical axis L2 of the camera 107 shown in FIG. 4. In the case of the present exemplary embodiment, since the parallel light source is used for the light source 108, the telecentric lens is used for the imaging lens 107A. A modulation transfer function (MTF) in the field of view of the camera 107 is generally uniform. Therefore, the variation in contrast due to a difference in position in the field of view is small, and the surface of the inspection target 10 can be faithfully imaged.

In FIG. 4, an optical axis of the illumination light output from the light source 108 is indicated by L1.

In FIG. 4, the normal of the surface of the inspection target 10 having a flat plate shape is indicated by N. In the case of the present exemplary embodiment, since the illumination light output from the light source 108 is specularly reflected on the surface of the inspection target 10 and is reflected in a direction of the camera 107, an angle formed by the optical axis L1 and the normal N and an angle formed by the optical axis L2 and the normal N is θ. The angle θ is, for example, 30° or 45°.

Incidentally, the surface of the actual inspection target 10 has structural or design irregularities, curved surfaces, steps, joints, fine irregularities formed in a molding process, and the like.

Therefore, in the present exemplary embodiment, an average value of orientations of the normal N of a region AR of interest in the inspection target 10 or the normal N of a specific position P of interest may be used as the normal N of the inspection target 10.

### Example of Operation Screen

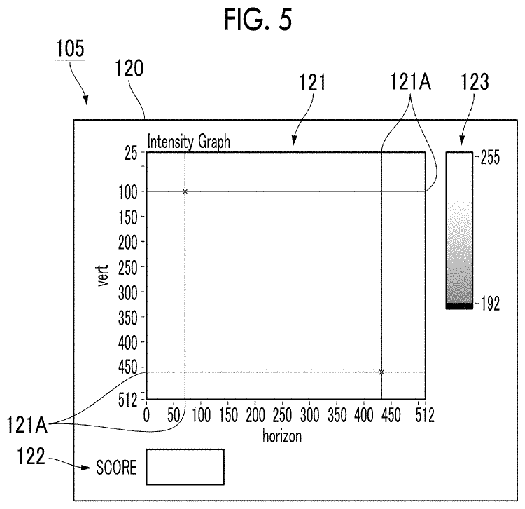

FIG. 5 is a diagram illustrating an example of an operation screen 120 displayed on the display 105. The operation screen 120 shown in FIG. 5 is displayed by turning on the light source 108 (see FIG. 4) by operating the power button and starting the imaging by the camera 107 (see FIG. 4).

An image display field 121 for displaying an image imaged by the camera 107, a score field 122 for displaying a calculated score, and an explanatory note 123 for displaying a brightness value expressed by shade of a grayscale image displayed in the image display field 121 are arranged on the operation screen 120 shown in FIG. 5.

In the case of the present exemplary embodiment, the grayscale image imaged in real time is displayed in the image display field 121 until the imaging button is operated. After the imaging button is operated, the grayscale image at a point in time at which the imaging button is operated is displayed.

The shade of the grayscale image displayed in the image display field 121 indicates a difference in a brightness level between pixels. In the case of the present exemplary embodiment, as the color of the pixel becomes darker, the brightness level becomes lower, and as the color of the pixel becomes lighter, the brightness level becomes higher.

Four lines 121A that give outer edges of the inspection range used for the calculation of the score are displayed in the image display field 121. A range surrounded by the four lines 121A is the inspection range. This is because a state of the surface other than the region to be inspected influences the score in a case where it is assumed that the entire imaged image is the inspection range.

In the case of FIG. 5, the shade of the gray scale image displayed in the image display field 121 corresponds to gradation values “192” to “255”.

In the present exemplary embodiment, since the color camera is used as the camera 107, a color image may be displayed in the image display field 121.

Inspection Operation

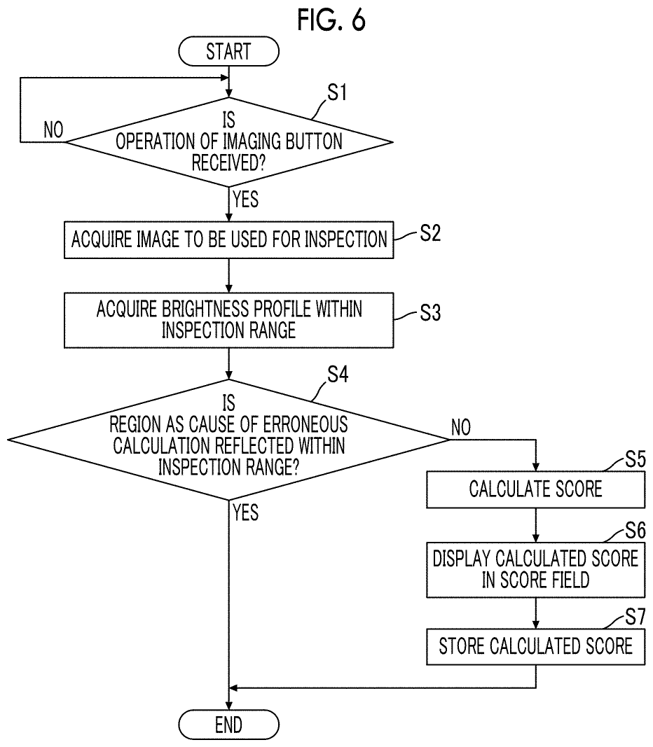

FIG. 6 is a flowchart illustrating an example of an inspection operation by the surface inspection apparatus 1 used in the fourth exemplary embodiment. A symbol S shown in the figure means a step.

The process shown in FIG. 6 is realized through the execution of the program by the processor 101 (see FIG. 4).

In the surface inspection apparatus 1 according to the present exemplary embodiment, the light source 108 (see FIG. 4) is turned on by operating the power button, and the imaging by the camera 107 (see FIG. 4) is started. The imaged image is displayed in real time in the image display field 121 (see FIG. 5) of the display 105 (see FIG. 4).

In the present exemplary embodiment, in a case where the operator checking the image displayed on the display 105 operates the imaging button, the image used for evaluating the quality of the surface is confirmed.

Therefore, the processor 101, which has started the inspection operation by operating the power button, determines whether or not the operation of the imaging button has been received (step S1). The operation of the operation button is an example of an operation of giving an instruction to start an inspection.

While a negative result is obtained in step S1, the processor 101 repeats the determination in step S1.

In a case where a positive result is obtained in step S1, the processor 101 acquires an image to be used for inspection (step S2). Specifically, the image displayed on the display 105 at a point in time at which the imaging button is operated is acquired.

In the case of the present exemplary embodiment, in a case where the imaging button is operated, the update of the image displayed in the image display field 121 (see FIG. 5) is stopped even though the imaging by the camera 107 is continued.

Subsequently, the processor 101 obtains a brightness profile within the inspection range (step S3). The brightness profile is an example of brightness information of the image.

In the case of the present exemplary embodiment, the processor 101 determines whether or not a region as a cause of the erroneous calculation is reflected within the inspection range by using the acquired brightness profile (step S4).

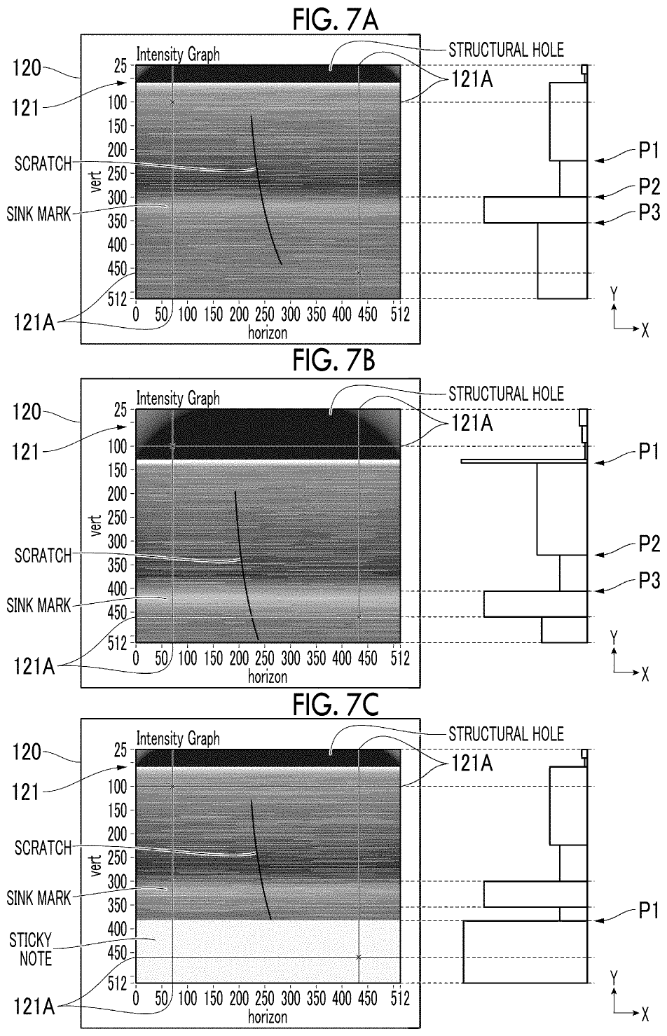

FIGS. 7A and 7B are diagrams illustrating a relationship between the imaged image and the brightness profile. FIG. 7A shows an image example in which a highly reliable score can be calculated and a corresponding brightness profile example, and FIGS. 7B and 7C show an image example in which a score having a reliability problem is calculated and a corresponding brightness profile example.

FIGS. 7A to 7C show only the image display field 121 of the operation screen 120. Further, the brightness profiles in FIGS. 7A to 7C are represented by omitting a fine waveform portion.

In the image shown in FIG. 7A, a structural hole and a structural edge are also reflected in addition to the sink mark and the scratch to be inspected. Since there is no object that reflects the illumination light on a focal plane in the structural hole portion, the reflected light is not incident on an imaging surface of the camera 107 (see FIG. 4) in the corresponding portion. Therefore, the corresponding region portion is displayed as low brightness.

However, in the case of the image shown in FIG. 7A, the structural hole or the like is positioned outside the inspection range surrounded by the four lines 121A. Therefore, the reliability of the score quantified on the surface including the sink marks and the scratches is not influenced.

In the case of the present exemplary embodiment, the brightness profile is given as a change in an X-axis direction in a brightness value (hereinafter referred to as a “representative brightness value”) representing each coordinate on a paper surface in an X-axis direction.

In the case of the present exemplary embodiment, the representative brightness value represents an integrated value of the brightness values of the pixels having the same Y coordinate. As the representative brightness value becomes larger, the pixel becomes brighter than the surroundings, and as the representative brightness value becomes smaller, the pixel becomes darker than the surroundings.

In step S4, the processor 101 determines, for example, whether or not an image as the cause of the erroneous calculation is reflected within the inspection range by one or both of a rate of change of the representative brightness value within the inspection range in the Y-axis direction and an area or an area ratio of the region of the brightness value that satisfies a predetermined condition within the inspection range. For example, in a case where the area or the area ratio exceeds a predetermined criterion, the processor 101 determines that the cause of the erroneous calculation is reflected.

As the brightness value that satisfies the predetermined condition, for example, the brightness value may be lower than a threshold value for determining low brightness, or the brightness value may be higher than a threshold value for determining high brightness.

Low brightness of which the brightness value is lower than the threshold value tends to appear, for example, in a region where a structural step or a concave portion having a large height difference as compared with the sink mark is formed. High brightness of which the brightness value is higher than the threshold value tends to appear in a region where, for example, external light or ambient light is incident through a gap or the like.

In the case of the present exemplary embodiment, the color camera is used as the camera 107 (see FIG. 4). Therefore, it is also possible to determine whether or not the image as the cause of the erroneous calculation is reflected within the inspection range by using the color information.

In the case of FIG. 7A, the rate of change of the brightness profile increases at positions of points P1 and P2, but the magnitude thereof is within a range of a predetermined rate of change or is equal to or less than a threshold value. Therefore, the image shown in FIG. 7A is determined as an image that does not include a structural hole, a sticky note, or the like. In the case of the image shown in FIG. 7A, the processor 101 obtains a negative result in step S4.

In the image shown in FIG. 7B, a structural hole and a structural edge are also reflected at an upper part within the inspection range.

In the case of the image of FIG. 7B, the structural hole portion appears black and the edge appears white. Therefore, the rate of change of the brightness profile is maximized at the position of the point P1.

Since the score is calculated by using an image within the inspection range, the score is influenced by an image such as a structural hole having a larger rate of change in the brightness value than the scratch or the sink mark.

Incidentally, the rate of change of the brightness profile at the position of the point P1 exceeds the range of the predetermined rate of change or the threshold value. Therefore, the image shown in FIG. 7B is determined as an image including the structural hole or the like. However, in a case where the color information of the color image is used, a black region different from the color of the surface of the inspection target is detected, and it may be determined that the structural hole or the like is included within the inspection range depending on the area and the area ratio.

In the case of the image shown in FIG. 7B, the processor 101 obtains a positive result in step S4.

The image shown in FIG. 7C is imaged at substantially the same position as in FIG. 7A.

However, in the image shown in FIG. 7C, the sticky note is reflected at a lower part of the inspection range. The sticky note is attached, for example, as a mark for a position to be inspected, but reflectance differs depending on a material. For example, the reflectance of the sticky note made of film is higher than the reflectance of the sticky note made of paper.

On the image shown in FIG. 7C, the rate of change of the brightness profile is maximized at the point P1 which is a boundary portion of the sticky note. Therefore, the image shown in FIG. 7C is determined as an image including the sticky note.

Further, in the example of FIG. 7C, a high-brightness region with little change in brightness appears continuously at the lower part of the inspection range. This region is a feature that does not originally appear in the inspection target 10. From this feature, it can be seen that the sticky note is reflected in the inspection range.

The reflection of the sticky note made of paper may be determined by, for example, specifying the color of the surface of the inspection target 10 in advance from the color image and detecting a region having a color different from the specified color.

In the case of the image shown in FIG. 7C, the processor 101 obtains a positive result in step S4.

The description is referred back to FIG. 6.

In a case where a positive result is obtained in step S4, the processor 101 ends the inspection operation without executing the calculation of the score or the like.

On the other hand, in a case where a negative result is obtained in step S4, the processor 101 calculates the score that quantifies the quality of the surface of the inspection range (step S5).

The score is calculated as, for example, a difference between a maximum value and a minimum value of the representative brightness value. The score depends on a width, a height, a depth, a number and the like of the irregularities formed on the surface. For example, even though the height of the convex portion and the depth of the concave portion are identical, the score of the partial region where the convex portion or the concave portion having a longer width is formed becomes high.

Further, even though the widths of the convex portion and the concave portion formed on the surface are identical, the score of the partial region where the higher convex portion and the deeper concave portion are formed becomes high. In the case of the present exemplary embodiment, a high score means poor quality.

The processor 101 that has calculated the score displays the calculated score in the score field 122 (see FIG. 5) (step S6).

Thereafter, the processor 101 stores the calculated score (step S7). The score is stored, for example, in the auxiliary storage device 104 (see FIG. 3). In a case where the score is stored, the image used to calculate the score is also stored in association with the score. Thereafter, the processor 101 ends the inspection operation.

### Display Example of Operation Screen

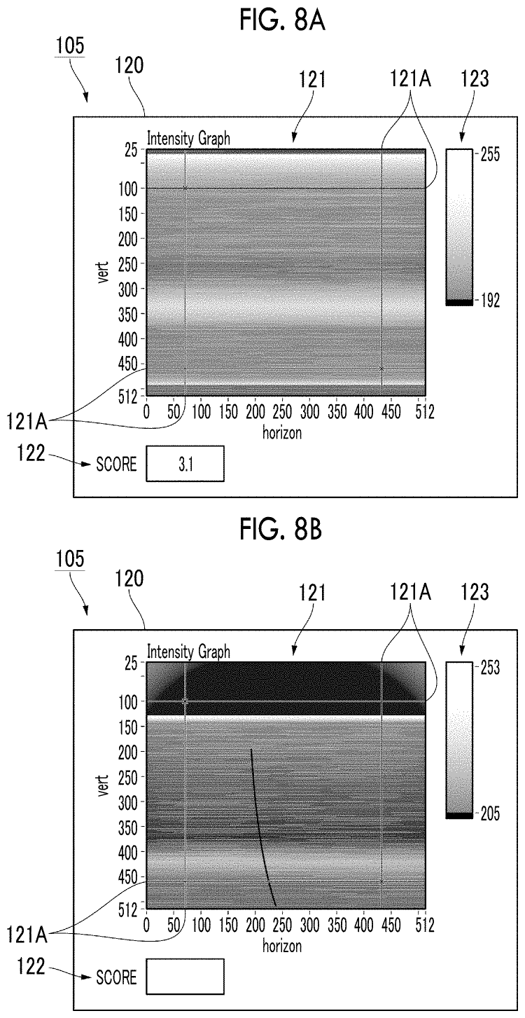

FIGS. 8A and 8B are diagrams illustrating a display example of an operation screen at the time of execution of a defect inspection. FIG. 8A shows a display example in a case where a region as a cause of erroneous calculation is not reflected in an inspection range, and FIG. 8B shows a display example in a case where the region as the cause of the erroneous calculation is reflected in the inspection range. In FIGS. 8A and 8B, portions corresponding to the portions in FIG. 5 are denoted by the corresponding reference numerals.

The image shown in FIG. 8A includes only the sink marks within the inspection range. Therefore, in the score field 122, the calculated score is displayed in the score field 122.

On the other hand, in the image shown in FIG. 8B, not only the sink mark to be inspected but also the structural hole or the like is reflected within the inspection range. Therefore, the score is not displayed in the score field 122.

In this manner, even though the imaging button is operated, since the score is not displayed, the operator can be aware of the reflection of the portion or the like having a possibility of being the cause of the erroneous calculation.

Since the score is not displayed even though the imaging button is operated, it is physically difficult for the operator who is not accustomed to the inspection to continue the inspection without noticing the abnormality of the score.

### Second Exemplary Embodiment

In a second exemplary embodiment, the surface inspection apparatus 1 (see FIG. 1) having the apparatus configuration described in the first exemplary embodiment is used. However, in the case of the surface inspection apparatus 1 used in the second exemplary embodiment, the content of the inspection operation is different from the content in the first exemplary embodiment.

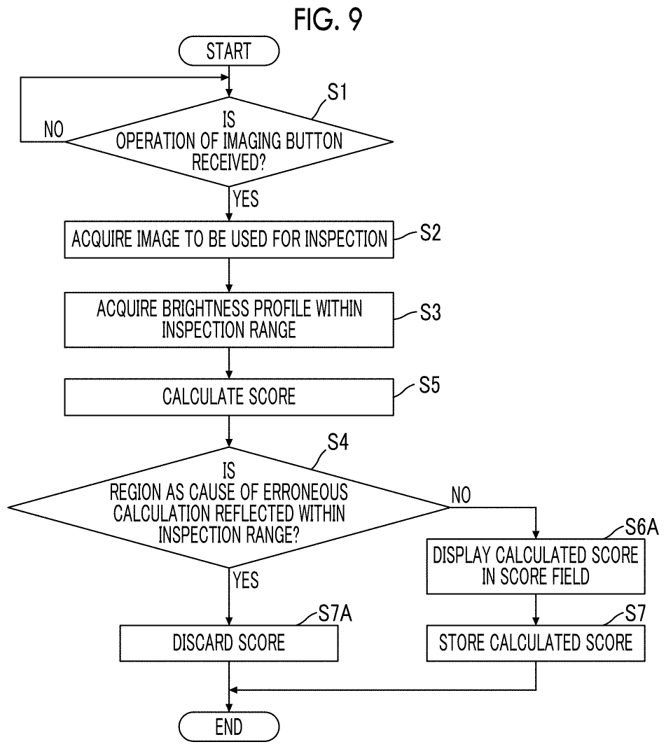

FIG. 9 is a flowchart illustrating an example of an inspection operation by the surface inspection apparatus 1 used in the second exemplary embodiment. In FIG. 9, portions corresponding to the portions in FIG. 6 are denoted by the corresponding reference numerals.

The process shown in FIG. 9 is also realized through the execution of the program by the processor 101 (see FIG. 4).

In the case of a processing operation shown in FIG. 9, step S5 is executed between steps S3 and S4. That is, in a case where the processor 101 acquires the brightness profile within the inspection range (step S3), the processor subsequently calculates the score of the inspection range (step S5).

Further, in a case where the score is calculated, the processor 101 determines whether or not the region as the cause of the erroneous calculation is reflected within the inspection range (step S4).

For the determination here, the same processing as in the first exemplary embodiment is used. However, since the score has already been calculated, the reflection of the structural features and the like that are not the target of the inspection may be determined by using the score. For example, in a case where the score is out of a predetermined range, the processor 101 may determine that the score is an abnormal value and may obtain a positive result in step S4. On the other hand, in a case where the score is in the predetermined range, the processor 101 may determine that the score is a normal value and may obtain a negative result in step S4.

On the other hand, in a case where a positive result is obtained in step S4, the processor 101 discards the score calculated in step S5 without displaying the score in the score field 122 (step S7A), and then ends the inspection operation.

In the case of the present exemplary embodiment, since the score having a possibility of including the cause of the erroneous calculation is not stored, a possibility of the erroneous determination based on recorded data is also avoided.

On the other hand, in a case where a negative result is obtained in step S4, the processor 101 displays the calculated score in the score field 122 (see FIG. 5) (step S6A). The subsequent processing operation is the same as in the first exemplary embodiment.

In the case of the present exemplary embodiment, an internal operation is different from the internal operation in the first exemplary embodiment, but the content displayed on the operation screen 120 is the same as the content in the first exemplary embodiment.

### Third Exemplary Embodiment

In a third exemplary embodiment, the surface inspection apparatus 1 (see FIG. 1) having the apparatus configuration described in the first exemplary embodiment is used. However, in the case of the surface inspection apparatus 1 used in the third exemplary embodiment, the content of the inspection operation is different from the content in the first exemplary embodiment.

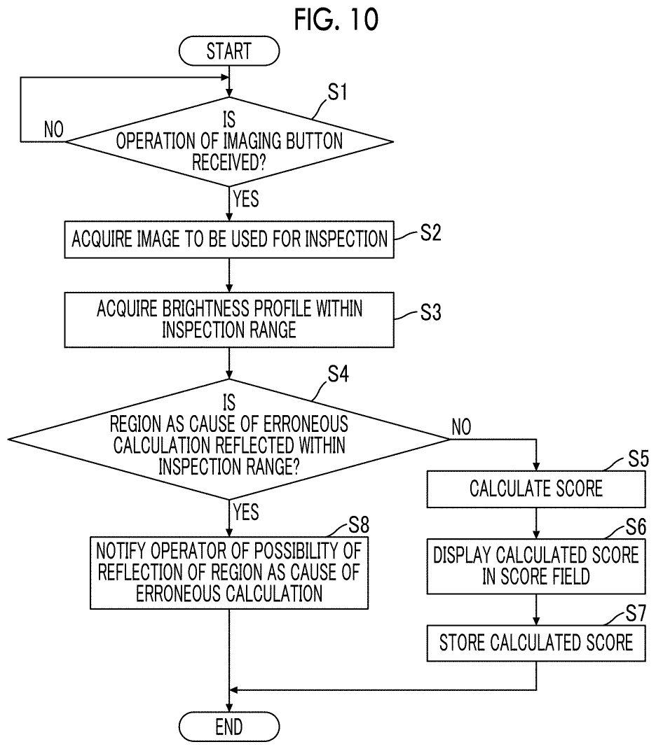

FIG. 10 is a flowchart illustrating an example of an inspection operation by the surface inspection apparatus 1 used in the third exemplary embodiment. In FIG. 10, portions corresponding to the portions in FIG. 6 are denoted by the corresponding reference numerals.

The process shown in FIG. 10 is also realized through the execution of the program by the processor 101 (see FIG. 4).

In the case of a processing operation shown in FIG. 10, the processing operation after the negative result is obtained in step S4 is the same as in the first exemplary embodiment. That is, the processor 101 calculates the score (step S5), displays the calculated score in the score field 122 (step S6), and stores the calculated score (step S7).

On the other hand, in a case where a positive result is obtained in step S4, the processor 101 notifies the operator of the possibility of the reflection of the region as the cause of the erroneous calculation (step S8), and then ends the inspection operation.

Examples of the notification method include a method using a display, a method using a sound, and a method using an indicator.

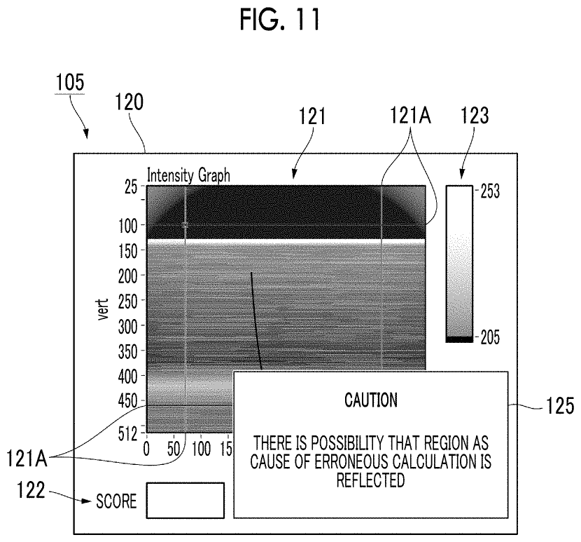

FIG. 11 is a diagram illustrating an example of a method for notifying the reflection of the region as the cause of the erroneous calculation. In FIG. 11, portions corresponding to the portions in FIG. 5 are denoted by the corresponding reference numerals.

In FIG. 11, a small screen 125 is displayed in a pop-up format on the operation screen 120. On the small screen 125, the possibility of the reflection is displayed by text. Specifically, a title “caution” and a sentence “there is a possibility that the region as the cause of the erroneous calculation is reflected” are displayed. However, either only the title or only the sentence may be used for the notification.

In FIG. 11, although the small screen 125 overlaps a part of the image display field 121, the small screen may be displayed at a position that does not overlap with the image display field 121.

In a case where an area where the small screen 125 and the image display field 121 overlap is small, the operator can confirm a location where there is a possibility of a problem through the confirmation of the image display field 121. However, even though the small screen 125 and the image display field 121 overlap, in a case where the overlapped portion is out of the inspection range, the confirmation by the operator is not substantially influenced.

A position where the small screen 125 is, for example, arranged can be moved on the screen by the operation by the operator.

A display size of the small screen 125 can be, for example, changed by the operation by the operator. Incidentally, a font size may be changed by changing the display size, or the switching between the notification of only the title and the notification including the text may be linked to the size change.

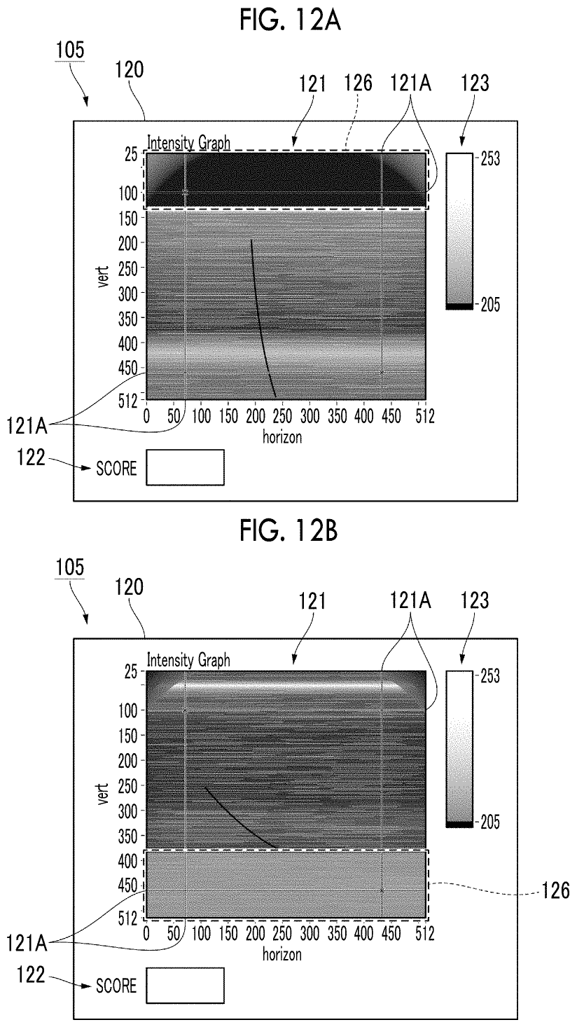

FIGS. 12A and 12B are diagrams illustrating another example of the method for notifying the reflection of the region as the cause of the erroneous calculation. FIGS. 12A and 12B show an example in which a location having a possibility of a problem is surrounded by a frame. In FIGS. 12A and 12B, portions corresponding to the portions in FIG. 5 are denoted by the corresponding reference numerals.

In FIG. 12A, an image in which a structural hole is reflected is displayed at an upper part of the inspection range. In FIG. 12A, a frame line 126 surrounding the structural hole portion reflected in the image display field 121 is indicated by a broken line.

On the other hand, FIG. 12B shows an image in which s sticky note is reflected in a lower part of the inspection range. Therefore, in FIG. 12B, a frame line 126 surrounding the sticky note portion reflected in the image display field 121 is indicated by a broken line.

In order to improve visibility, the frame line 126 may be displayed with high brightness, or may be displayed in color. It may be easier for the operator to notice by turning on and off the frame line 126.

In FIGS. 12A and 12B, although the outside of the inspection range is also included in the range surrounded by the frame line 126, the frame line 126 may be indicated by surrounding only a portion that becomes a problem in calculating the score, that is, only a partial portion within the inspection range that becomes a problem.

In the case of FIGS. 12A and 12B, although the entire location having the problem is surrounded by the frame line 126, for example, an arrow may be used to indicate the corresponding location. For example, four corners of the corresponding region may be indicated by symbols such as triangles. For example, the corresponding region portion may be indicated by being turned on and off. It is easier to notice the region having the problem by turning on and off.

The display by the frame line 126 and the display by the small screen 125 (see FIG. 11) may be combined.

Although the above description is an example of “method using a display” for notification, in the case of “method using a sound”, for example, a warning sound or the like may be output, or a voice may be output. For example, a beep sound or a voice saying “there is a possibility that the region as the cause of the erroneous calculation is reflected” may be output.

In the case of “method using an indicator” for notification, for example, an indicator arranged in the vicinity of the operation screen 120 may be turned on, and the operator may be notified that the problem occurs in the inspection of the inspection target 10 (see FIG. 1).

The indicator may be turned on in green in a case where there is no problem and may be turned on in yellow or red in a case where the problem is suspected. In this case, the color of the indicator allows the operator to know a cause that the score is not displayed.

The indicator is not limited to the case where the indicator is arranged as a physical device, and may be an indicator on the display 105 (see FIG. 3).

### Fourth Exemplary Embodiment

In a fourth exemplary embodiment, the surface inspection apparatus 1 (see FIG. 1) having the apparatus configuration described in the first exemplary embodiment is used. However, in the case of the surface inspection apparatus 1 used in the fourth exemplary embodiment, the content of the inspection operation is different from the content in the first exemplary embodiment.

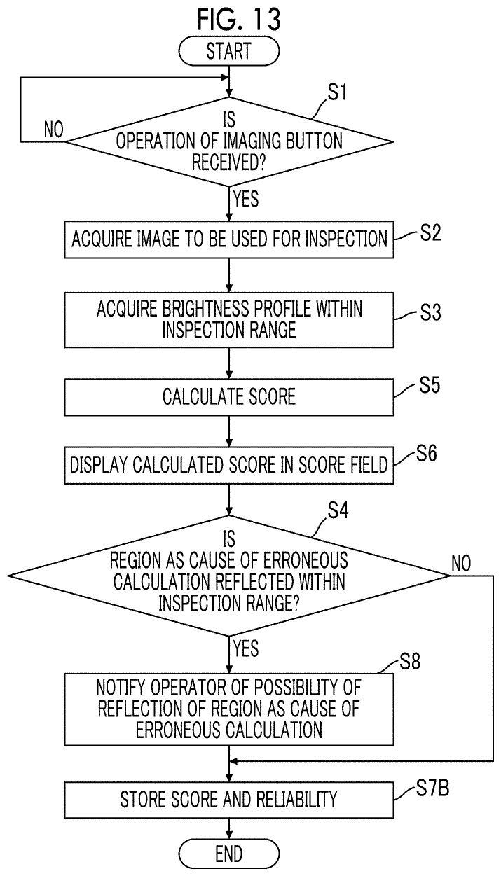

FIG. 13 is a flowchart illustrating an example of an inspection operation by the surface inspection apparatus 1 used in the fourth exemplary embodiment. In FIG. 13, portions corresponding to the portions in FIGS. 6 and 10 are denoted by the corresponding reference numerals.

The process shown in FIG. 13 is also realized through the execution of the program by the processor 101 (see FIG. 4).

In the case of a processing operation shown in FIG. 13, in a case where the processor 101 acquires the brightness profile within the inspection range (step S3), the processor calculates the score as in the case of the second exemplary embodiment (step S5).

Subsequently, the processor 101 displays the calculated score in the score field 122 (see FIG. 5) (step S6). That is, the processor 101 in the present exemplary embodiment calculates and displays the score regardless of whether or not the cause of the erroneous calculation is included in the inspection range.

Thereafter, the processor 101 determines whether or not the region as the cause of the erroneous calculation is reflected within the inspection range (step S4).

In a case where a negative result is obtained in step S4, the processor 101 stores the score and the reliability (step S7B), and then ends the inspection operation. The reliability here means “reliable”.

On the other hand, in a case where a positive result is obtained in step S4, the processor 101 notifies the operator of the possibility of the reflection of the region as the cause of the erroneous calculation (step S8), and then stores the score and the reliability. The reliability here means “unreliable”.

In the case of the present exemplary embodiment, although the score is displayed in the score field 122 even though the cause of the erroneous calculation is reflected, the fact that the displayed score is unreliable is simultaneously displayed on the operation screen.

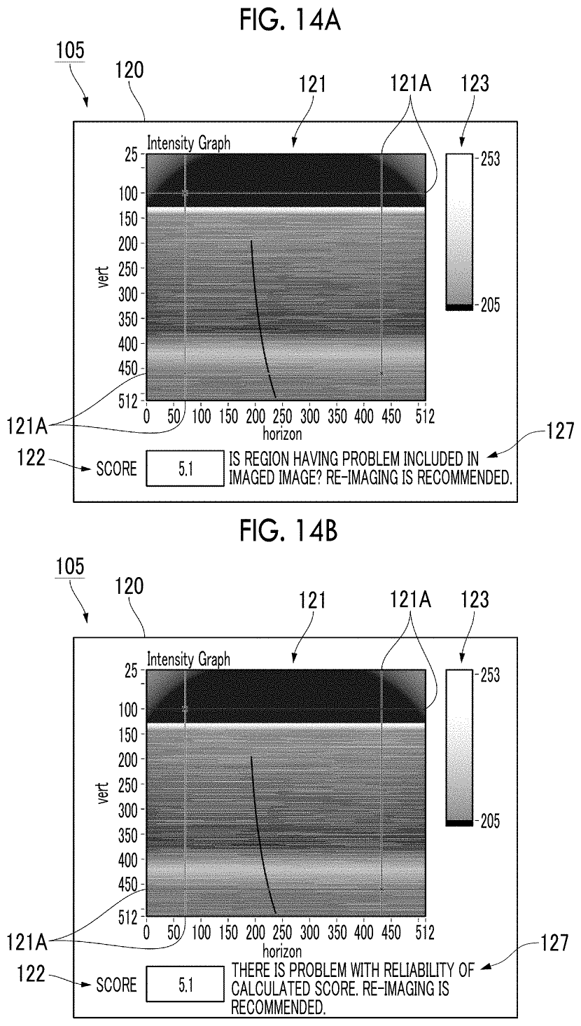

FIGS. 14A and 14B are diagrams illustrating a display example of the operation screen 120 in a case where the region as the cause of the erroneous calculation is reflected. FIG. 14A shows a notification example of reflection, and FIG. 14B shows a notification example of reliability. In FIGS. 14A and 14B, portions corresponding to the portions in FIG. 5 are denoted by the corresponding reference numerals.

In both the case of FIG. 14A and the case of FIG. 14B, the image display field 121 shows an example in which a structural hole is reflected at an upper part of the inspection range. In both the case of FIG. 14A and the case of FIG. 14B, “5.1” is displayed as the score in the score field 122. This value is a value larger than a score of “3.1” in a case where the structural hole is not reflected.

However, in FIGS. 14A and 14B, a sentence 127 notifying the reflection of the cause of the erroneous calculation is displayed along with the score field 122.

In the case of FIG. 14A, two sentences 127 of “is the region having the problem included in the imaged image?” and “re-imaging is recommended.” are displayed. Since this sentence 127 is not displayed in a case where the cause of the erroneous calculation is not reflected, it is easy to draw the attention of the operator. The sentence 127 is displayed in text that there is a problem with the imaged image. Therefore, unlike the case where only the notification that re-imaging is recommended is given, erroneous imaging can be prevented from being repeated.

In the case of FIG. 14B, two sentences 127 of “there is a problem with the reliability of the calculated score.” and “re-imaging is recommend.” are displayed. Since this sentence 127 is also not displayed in a case where the cause of the erroneous calculation is not reflected, it is easy to draw the attention of the operator. The sentence 127 is displayed in text that there is a problem with the reliability of the displayed score. Therefore, it is possible to cause the operator to understand that the value of the displayed score need not be used as the result of the inspection. Unlike the case where only the notification that re-imaging is recommended is given, erroneous imaging can be prevented from being repeated.

### Fifth Exemplary Embodiment

In a fifth exemplary embodiment, the surface inspection apparatus 1 (see FIG. 1) having the apparatus configuration described in the first exemplary embodiment is used. However, in the case of the surface inspection apparatus 1 used in the fifth exemplary embodiment, the content of the inspection operation is different from the content in the first exemplary embodiment.

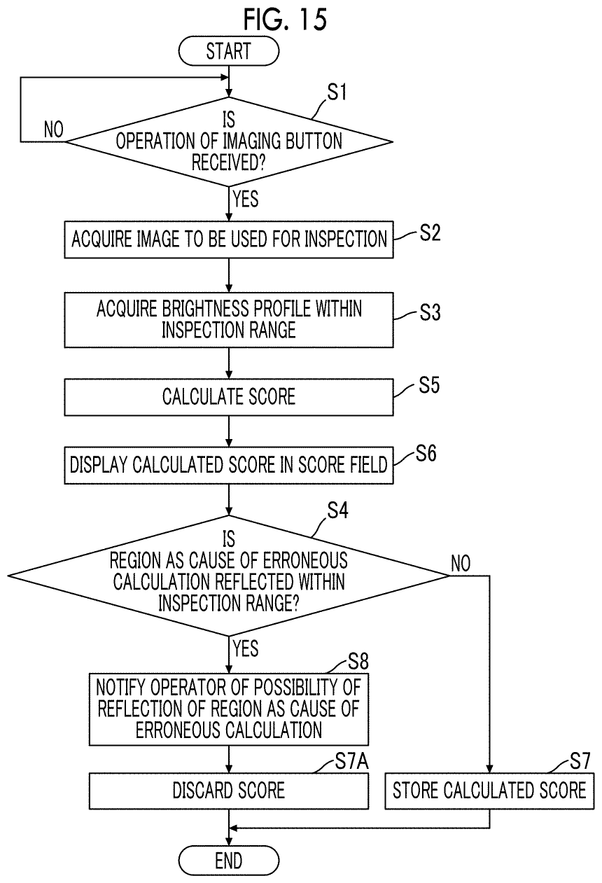

FIG. 15 is a flowchart illustrating an example of an inspection operation by the surface inspection apparatus 1 used in the fifth exemplary embodiment. In FIG. 15, portions corresponding to the portions in FIGS. 6, 9, and 10 are denoted by the corresponding reference numerals.

The process shown in FIG. 15 is also realized through the execution of the program by the processor 101 (see FIG. 4).

In the case of a processing operation shown in FIG. 15, as in the case of the above-described fourth exemplary embodiment, the score is calculated and displayed before it is determined whether or not the cause of the erroneous calculation is included in the inspection range in step S4.

A difference is a processing operation after the determination in step S4.

In the present exemplary embodiment, in a case where a negative result is obtained in step S4, the processor 101 stores the calculated score (step S7) and ends the inspection operation. That is, in the case of the present exemplary embodiment, the score is stored without adding information on the reliability.

On the other hand, in a case where a positive result is obtained in step S4, as in the case of the fourth exemplary embodiment, the processor 101 notifies the operator of the possibility of the reflection of the region as the cause of the erroneous calculation (step S8), and discards the score (step S7A).

In the case of the present exemplary embodiment, the score is stored only in a case where the region as the cause of the erroneous calculation is not reflected in the inspection range, and the score is not stored in a case where the region as the cause of the erroneous calculation is reflected in the inspection range.

Therefore, in the present exemplary embodiment, as in the case of the above-described fourth exemplary embodiment, even though the score is recorded without giving the information on the reliability, the erroneous determination of the operator who confirms the recorded score is prevented.

### Sixth Exemplary Embodiment

In a sixth exemplary embodiment, the surface inspection apparatus 1 (see FIG. 1) having the apparatus configuration described in the first exemplary embodiment is used. However, in the case of the surface inspection apparatus 1 used in the sixth exemplary embodiment, the content of the inspection operation is different from the content in the first exemplary embodiment.

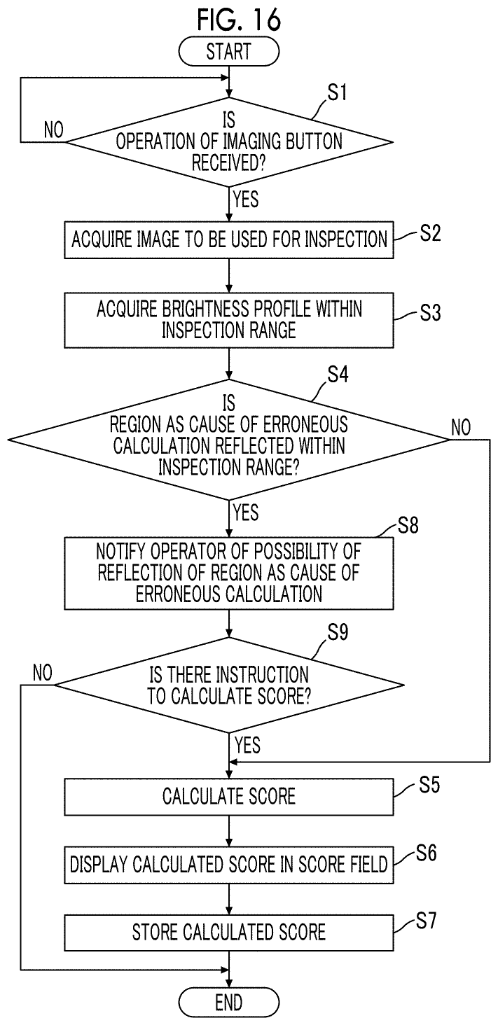

FIG. 16 is a flowchart illustrating an example of an inspection operation by the surface inspection apparatus 1 used in the sixth exemplary embodiment. In FIG. 16, portions corresponding to the portions in FIGS. 6 and 10 are denoted by the corresponding reference numerals.

The process shown in FIG. 16 is also realized through the execution of the program by the processor 101 (see FIG. 4).

In the case of the present exemplary embodiment, as in the case of the first exemplary embodiment, the processor 101 determines whether or not the region as the cause of the erroneous calculation is reflected within the inspection range before the score is calculated (step S4).

In a case where a negative result is obtained in step S4, the processor 101 calculates the score (step S5) and displays the calculated score in the score field 122 (step S6).

In the present exemplary embodiment, the processor 101 stores the calculated score (step S7) and ends the inspection operation.

On the other hand, in a case where a positive result is obtained in step S4, the processor 101 notifies the operator of the possibility of the reflection of the region as the cause of the erroneous calculation (step S8).

Incidentally, there is a possibility of the erroneous calculation in the determination in step S4. Therefore, the processor 101 in the present exemplary embodiment determines whether or not there is an instruction to calculate the score subsequently to the notification in step S8 (step S9).

For example, in a case where the operator determines that the cause of the erroneous calculation is reflected within the inspection range, the processor 101 obtains a negative result in step S9.

In a case where a negative result is obtained in step S9, the processor 101 ends the inspection operation as it is.

On the other hand, in a case where the operator determines that the cause of the erroneous calculation is not reflected within the inspection range, the processor 101 obtains a positive result in step S9.

In a case where a positive result is obtained in step S9, the processor 101 calculates the score (step S5), displays the calculated score in the score field 122 (step S6), stores the calculated score (step S7), and ends the inspection operation.

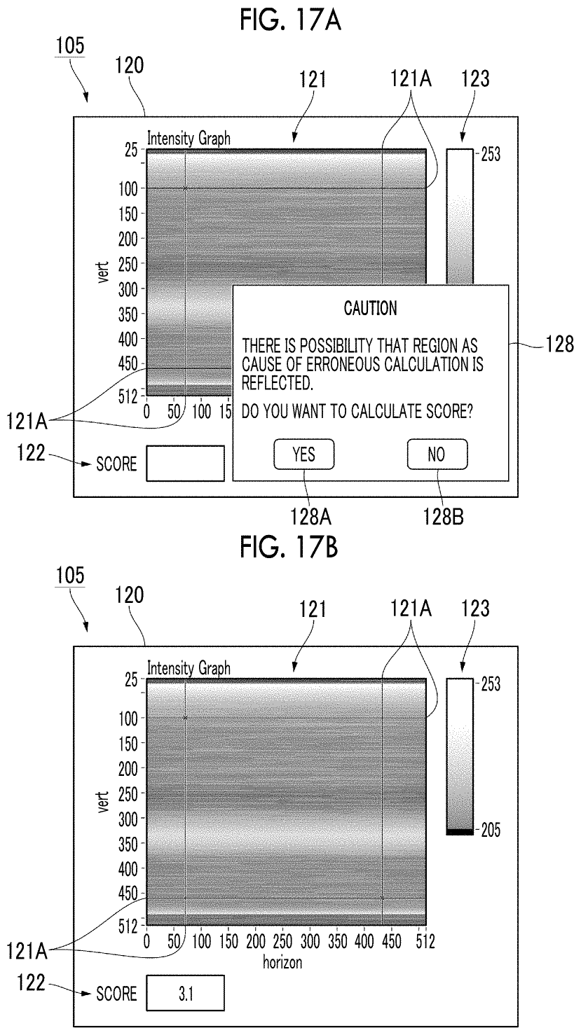

FIGS. 17A and 17B are diagrams illustrating a display example of the operation screen 120 in a case where there is a possibility that the region as the cause of the erroneous calculation is reflected. FIG. 17A shows a notification example of reflection, and FIG. 17B shows a display example in a case where a score is calculated based on an instruction of an operator. In FIGS. 17A and 17B, portions corresponding to the portions in FIG. 5 are denoted by the corresponding reference numerals.

In the case of FIG. 17A, a small screen 128 is displayed in a pop-up format on the operation screen 120. On the small screen 128, the possibility of the reflection is displayed by text. Specifically, a title of “caution” and sentences of “there is a possibility that the region as the cause of the erroneous calculation is reflected.” and “do you want to calculate the score?” are displayed.

On the small screen 128, buttons 128A and 128B used for receiving instructions to calculate the score are arranged. The button 128A is used for the instruction to calculate the score, and the button 128B is used for the instruction not to calculate the score.

In the case of FIG. 17A, the reflection of the structural hole or the sticky note is not observed within the inspection range.

In this case, the operator can instruct the processor 101 that the score can be calculated by operating the button 128A.

In a case where the button 128A is operated, the operation screen 120 is switched to the operation screen 120 shown in FIG. 17B, and the score is displayed in the score field 122.

The operator can know the result of the inspection of the sink mark or the like which is the inspection target by displaying the score. The processor 101 stores the calculated score in the auxiliary storage device 104 (see FIG. 3) or the like.

In a case where the button 128B is operated, the processor 101 switches the display of the image display field 121 to the display of the image being imaged in real time.

### Seventh Exemplary Embodiment

In a seventh exemplary embodiment, the surface inspection apparatus 1 (see FIG. 1) having the apparatus configuration described in the first exemplary embodiment is used. However, in the case of the surface inspection apparatus 1 used in the seventh exemplary embodiment, the content of the inspection operation is different from the content in the first exemplary embodiment.

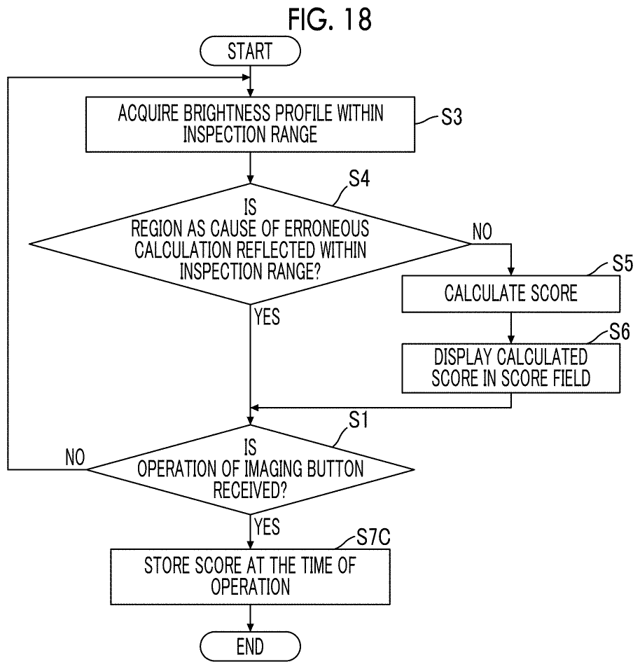

FIG. 18 is a flowchart illustrating an example of an inspection operation by the surface inspection apparatus 1 used in the seventh exemplary embodiment. In FIG. 18, portions corresponding to the portions in FIG. 6 are denoted by the corresponding reference numerals.

The process shown in FIG. 18 is also realized through the execution of the program by the processor 101 (see FIG. 4).

In the case of the present exemplary embodiment, the surface inspection apparatus 1 (see FIG. 1) that does not require the operation of the imaging button in calculating the score will be described.

Therefore, in a case where the light source 108 (see FIG. 4) is turned on by operating the power button, the processor 101 acquires the brightness profile within the inspection range for the image imaged by the camera 107 (see FIG. 4) in real time (step S3). That is, the acquisition of the brightness profile within the inspection range is executed regardless of the operation of the imaging button.

Subsequently, the processor 101 determines whether or not the region as the cause of the erroneous calculation is reflected within the inspection range as in the first exemplary embodiment (step S4).

In a case where a negative result is obtained in step S4, the processor 101 calculates the score (step S5) and displays the calculated score in the score field 122 (step S6). Thereafter, the processor 101 determines whether or not the operation of the imaging button has been received (step S1).

On the other hand, in a case where a positive result is obtained in step S4, the processor 101 executes the determination in step S1 without calculating the score.

While a negative result is obtained in step S1, the processor 101 returns to step S3, and repeats the above-mentioned processing in step S1.

On the other hand, in a case where a positive result is obtained in step S1, the processor 101 stores the score at the time of operation (step S7C) and ends the inspection operation. In a case where the operation of the imaging button is received in a state where the score is displayed, the storing of the score in step S7C is skipped.

In the case of the present exemplary embodiment, in a case where the cause of the erroneous calculation is not included within the inspection range of the image being imaged in real time, the score is calculated and displayed in the score field 122. Even though the score is displayed, since the imaging in real time is continued, in a case where the imaged portion changes, the value of the score displayed in the score field 122 also changes.

In a case where the cause of the erroneous calculation is included in the inspection range in a process of changing the imaged portion, the score in the score field 122 is not displayed at this point in time.

Therefore, the operator can determine whether or not the cause of the erroneous calculation is reflected by confirming whether or not the score is displayed simultaneously with confirming the image being imaged in real time.

In the case of the present exemplary embodiment, the score to be stored as the result of the inspection can be instructed by operating the imaging button.

### Eighth Exemplary Embodiment

In an eighth embodiment, the surface inspection apparatus 1 (see FIG. 1) having the apparatus configuration described in the first exemplary embodiment is used. However, in the case of the surface inspection apparatus 1 used in the eighth embodiment, the content of the inspection operation is different from the content in the first exemplary embodiment.

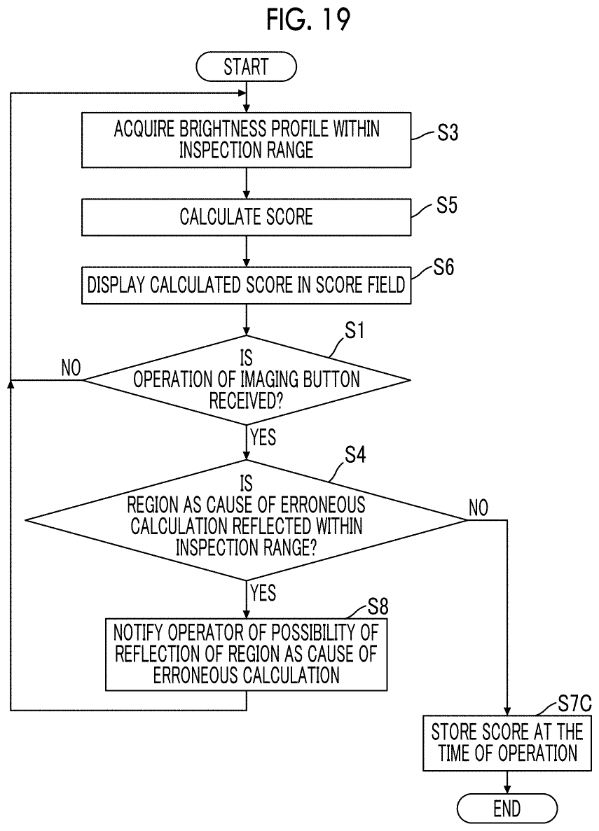

FIG. 19 is a flowchart illustrating an example of an inspection operation by the surface inspection apparatus 1 used in the eighth exemplary embodiment. In FIG. 19, portions corresponding to the portions in FIG. 18 are denoted by the corresponding reference numerals.

The process shown in FIG. 19 is also realized through the execution of the program by the processor 101 (see FIG. 4).

In the case of the present exemplary embodiment, in a case where the light source 108 (see FIG. 4) is turned on by operating the power button, the brightness profile within the inspection range is acquired for the image imaged by the camera 107 (see FIG. 4) in real time (step S3). That is, the acquisition of the brightness profile within the inspection range is executed regardless of the operation of the imaging button.

Subsequently, the processor 101 calculates the score (step S5) and displays the calculated score in the score field 122 (step S6).

In the case of the present exemplary embodiment, the score for the image being imaged in real time is constantly calculated and displayed in the score field 122. That is, the abnormal score is also displayed in the score field 122.

In this state, the processor 101 determines whether or not the operation of the imaging button has been received (step S1). The processor 101 obtains a negative result in step S1 and returns to step S3 while the operator does not determine the portion to be inspected.

On the other hand, in a case where the operator determines the portion to be inspected, the processor 101 obtains a positive result in step S1 and determines whether or not the region as the cause of the erroneous calculation is reflected within the inspection range (step S4).

In a case where a negative result is obtained in step S4, the processor 101 stores the score at the time of operation of the imaging button (step S7C), and ends the inspection operation.

On the other hand, in a case where a positive result is obtained in step S4, the processor 101 notifies the operator of the possibility of the reflection of the region as the cause of the erroneous calculation (step S8), and returns to step S3.

That is, in a case where the imaging button is operated in a state where the cause of the erroneous calculation is reflected, the processor 101 repeats the calculation and the display of the score for the image being imaged in real time after the operator of the attention is notified.

The above-described method can be used for the notification.

An outer frame of the image display field 121 may be displayed in red. In a case where the cause of the erroneous calculation is not reflected, the outer frame of the image display field 121 may be displayed in green.

Since the notification is executed simultaneously with the operation of the imaging button, the operator can notice that there is a problem in the reliability of the score in a case where the imaging button is pressed.

### Ninth Exemplary Embodiment

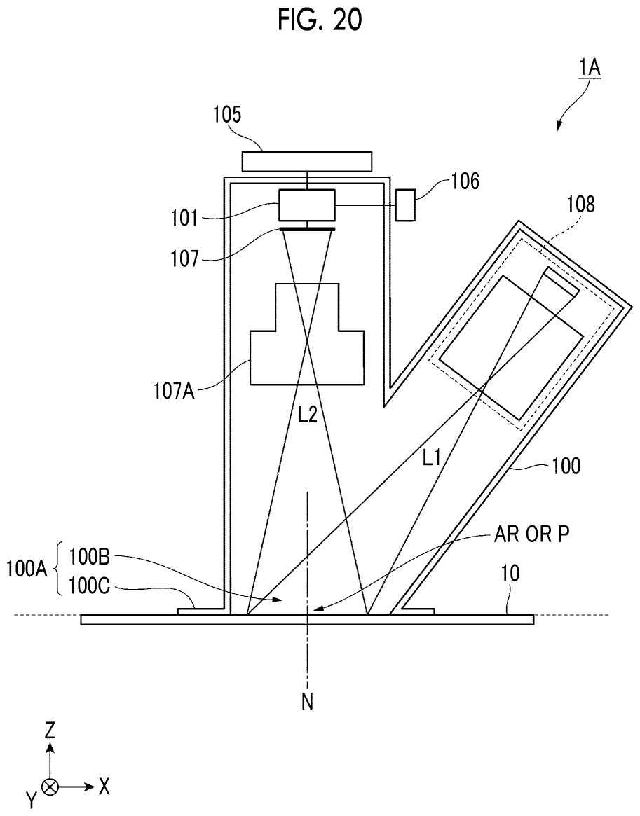

FIG. 20 is a diagram illustrating a usage example of a surface inspection apparatus 1A used in a ninth exemplary embodiment. In FIG. 20, portions corresponding to the portions in FIG. 4 are denoted by the corresponding reference numerals.

The present exemplary embodiment is the same as the first exemplary embodiment except that the structure of the optical system is different from the structure in the first exemplary embodiment.

Specifically, a point light source or a surface light source which is a non-parallel light source is used as the light source 108, and a non-telecentric lens is used as the imaging lens 107A.

The telecentric lens or the parallel light source is not used, and thus, the apparatus 1A used in the present exemplary embodiment can be downsized and the cost can be reduced as compared with the surface inspection apparatus 1 (see FIG. 1) described in the first exemplary embodiment.

The structure of the optical system described in the present exemplary embodiment can be used for any of the inspection operations of the above-described second to eighth exemplary embodiments.

### Tenth Exemplary Embodiment

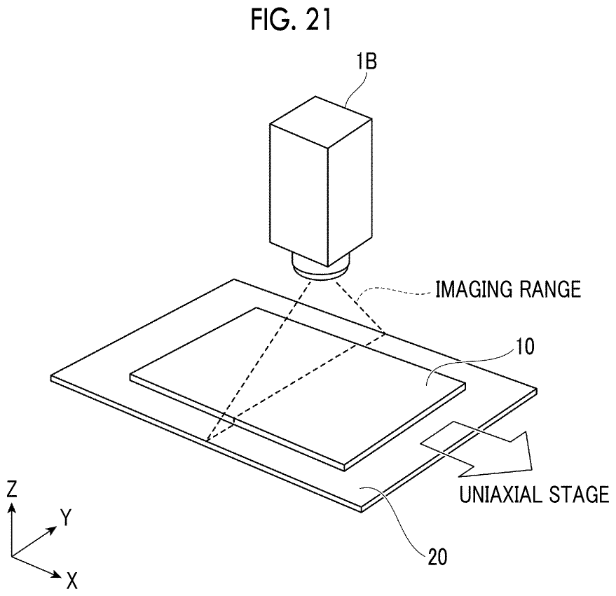

FIG. 21 is a diagram illustrating a usage example of a surface inspection apparatus 1B used in a tenth exemplary embodiment. In FIG. 21, portions corresponding to the portions in FIG. 1 are denoted by the corresponding reference numerals.

A so-called line camera is used for the surface inspection apparatus 1B used in the present exemplary embodiment. Therefore, the imaging range is linear.

In the case of the present exemplary embodiment, at the time of inspection, the inspection target 10 is moved in a direction of an arrow while being installed on a uniaxial stage 20. By moving the uniaxial stage 20 in one direction, the entire inspection target 10 is imaged. The present exemplary embodiment is the same as the first exemplary embodiment except that the method for imaging the image is different from the first exemplary embodiment.

The positional relationship between the camera 107 (see FIG. 4) and the light source 108 (see FIG. 4) is identical to the positional relationship between the camera and the light source of the first exemplary embodiment, except that the line camera is used as the camera 107 (see FIG. 4). The structure described in the ninth exemplary embodiment can be adopted for the optical system.

The surface inspection apparatus 1B described in the present exemplary embodiment can also be used for any of the inspection operations of the above-described second to eighth embodiments.

### OTHER EXEMPLARY EMBODIMENTS

(1) Although the exemplary embodiments of the present invention have been described above, the technical scope of the present invention is not limited to the scope described in the above-described exemplary embodiments. It is clear from the description of the claims that the above-described exemplary embodiments with various modifications or improvements are also included in the technical scope of the present invention.

(2) In the above-described exemplary embodiments, the color camera is used as the camera 107 (see FIG. 4), but a monochrome camera may also be used. The surface of the inspection target 10 (see FIG. 1) may be inspected by using only the green (G) component of the color camera.

(3) In the above-described exemplary embodiments, the white light source is used as the light source 108 (see FIG. 4), but the illumination light may be any color.

The illumination light is not limited to visible light, but may be infrared light, ultraviolet light, or the like.

(4) In the above-described exemplary embodiments, the surface inspection apparatus 1 (see FIG. 1) using one light source 108 (see FIG. 4) has been described, but the surface of the inspection target 10 is illuminated by using a plurality of light sources.

For example, two light sources may be used. In that case, one light source may be arranged at an angle at which a mirror-reflected light component is mostly incident on the camera 107 (see FIG. 4), and the other light source may be arranged at an angle at which a diffusely reflected light component is mostly incident on the camera 107. In this case, the two light sources may be arranged on both sides of the optical axis of the camera 107, or may be arranged on one side with respect to the optical axis of the camera 107.

(5) In the above-described exemplary embodiments, the processor 101 (see FIG. 4) of the surface inspection apparatus 1 (see FIG. 1) that images the inspection target 10 (see FIG. 1) executes the function of determining whether or not the cause of the erroneous calculation is reflected within the inspection range, but the same function may be realized by a processor of an external computer or a server.

(6) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A surface inspection apparatus comprising:
an imaging device that images a surface of an object to be inspected; and
a processor configured to:
calculate an evaluation value of a texture of the object through processing of an image imaged by the imaging device; and
detect reflection of a cause of erroneous calculation of the image within a specific range based on at least brightness information of the image.

2. The surface inspection apparatus according to claim 1, wherein the processor is configured not to:
display the evaluation value on a screen in a case where the reflection of the cause of the erroneous calculation is detected.

3. The surface inspection apparatus according to claim 2, wherein the processor is configured not to:
calculate the evaluation value in a case where the reflection of the cause of the erroneous calculation is detected.

4. The surface inspection apparatus according to claim 2, wherein the processor is configured not to:
display the evaluation value on a screen even though the evaluation value is calculated in a case where the reflection of the cause of the erroneous calculation is detected.

5. The surface inspection apparatus according to claim 1, wherein the processor is configured to:
notify an operator of the detection of the reflection in a case where the reflection of the cause of the erroneous calculation is detected.

6. The surface inspection apparatus according to claim 5, wherein the processor is configured to:
display the detection of the reflection of the cause of the erroneous calculation in text on a screen.

7. The surface inspection apparatus according to claim 5, wherein the processor is configured to:
display a detected region portion on a screen in a case where the reflection of the cause of the erroneous calculation is detected.

8. The surface inspection apparatus according to claim 5, wherein the processor is configured to:
notify that the evaluation value is not a normal value in a case where the reflection of the cause of the erroneous calculation is detected.

9. The surface inspection apparatus according to claim 1, wherein the processor is configured to:
execute the calculation of the evaluation value in a case where an instruction to calculate the evaluation value is received.

10. The surface inspection apparatus according to claim 2, wherein the processor is configured to:
execute the calculation of the evaluation value in a case where an instruction to calculate the evaluation value is received.

11. The surface inspection apparatus according to claim 3, wherein the processor is configured to:
execute the calculation of the evaluation value in a case where an instruction to calculate the evaluation value is received.

12. The surface inspection apparatus according to claim 4, wherein the processor is configured to:
execute the calculation of the evaluation value in a case where an instruction to calculate the evaluation value is received.

13. The surface inspection apparatus according to claim 5, wherein the processor is configured to:
execute the calculation of the evaluation value in a case where an instruction to calculate the evaluation value is received.

14. The surface inspection apparatus according to claim 6, wherein the processor is configured to:
execute the calculation of the evaluation value in a case where an instruction to calculate the evaluation value is received.

15. The surface inspection apparatus according to claim 7, wherein the processor is configured to:
execute the calculation of the evaluation value in a case where an instruction to calculate the evaluation value is received.

16. The surface inspection apparatus according to claim 8, wherein the processor is configured to:
execute the calculation of the evaluation value in a case where an instruction to calculate the evaluation value is received.

17. The surface inspection apparatus according to claim 1,
wherein the cause of the erroneous calculation is an image in which an abnormal value appears in a rate of change in a brightness value in a specific direction of the image.

18. The surface inspection apparatus according to claim 1,
wherein the cause of the erroneous calculation is an image in which an area of a region in which a specific brightness value appears within the specific range exceeds a reference.

19. A non-transitory computer readable medium storing a program causing a computer for processing an image obtained by imaging a surface of an object to be inspected by an imaging device to realize a function comprising:
detecting reflection of a cause of erroneous calculation of the image within a specific range based on at least brightness information of the image.

20. A surface inspection method comprising:
detecting reflection of a cause of erroneous calculation of an image within a specific range based on at least brightness information of the image.
